(19) United States
(12) Patent Application Publication
(10) Pub. No.: US 2025/0285009 A1
(43) Pub. Date: Sep. 11, 2025

(54) SYSTEMS AND METHODS FOR SAMPLING AND TRAINING IN A MACHINE LEARNING ENVIRONMENT

(71) Applicant: JPMORGAN CHASE BANK, N.A., New York, NY (US)

(72) Inventors: Niyati GUPTA, Jaipur (IN); Dhiraj UNHALE, Thane (IN); Sanjay RAO, Thane (IN); Sagar SAKHARE, Pune (IN)

(21) Appl. No.: 18/644,999

(22) Filed: Apr. 24, 2024

(30) Foreign Application Priority Data
Mar. 6, 2024 (IN) 202411015781

(51) Int. Cl. G06N 20/00

(52) U.S. Cl. CPC G06N 20/00

(57) ABSTRACT

The techniques described herein relate to a method including: retrieving a subset of data files from an original dataset, wherein data files not included in the subset of data files are a remaining dataset; dividing the subset of data files into an initial training dataset and a validation dataset; executing an in initial training pass on a machine learning model, wherein the initial pass trains the model using the initial training dataset; determining, after the initial pass, a predictive accuracy of the model using the remaining dataset; determining, by a targeted sampling process, a number of least learned data files from the remaining dataset; generating a second training dataset including the number of least learned data files; and executing a second pass on the model, wherein the second pass trains the machine learning model using the second training dataset.

### RELATED APPLICATIONS

This application claims the benefit of and priority to Indian Provisional Patent Application Ser. No. 202411015781, filed Mar. 6, 2024, the disclosure of which is hereby incorporated by reference in its entirety.

### BACKGROUND

### 1. Field of The Disclosure

Aspects generally relate to systems and methods for sampling and training in a machine learning environment.

### 2. Description of the Related Art

In moving towards automated processing of digital documents and images, incorporation of machine learning (ML) techniques in business processes can be beneficial. Challenges still exist, however, in achieving fast, efficient, and effective training of ML models. One such challenge includes the selection of highly relevant training samples from large repositories of data samples. Targeted selection of samples (e.g., document files, image files, and data samples) from a dataset that will provide the most training or re-training benefit during a model training exercise can decrease model training time, data annotation time, overall cost (data labelling resource and infrastructure) and increase resource utilization and time-to-market.

### SUMMARY

In some aspects, the techniques described herein relate to a computer-implemented method including: retrieving a subset of data files from an original dataset, wherein data files not included in the subset of data files are a remaining dataset; dividing the subset of data files into an initial training dataset and an evaluation dataset; executing an in initial training pass on a machine learning model, wherein the initial training pass trains the machine learning model using the initial training dataset; determining, after the initial training pass, a predictive accuracy of the machine learning model using the evaluation dataset; determining, by a targeted sampling process, a number of least learned data files from the remaining dataset; generating a second training dataset including the number of least learned data files, wherein the second training dataset includes the initial training dataset; and executing a second training pass on the machine learning model, wherein the second training pass trains the machine learning model using the second training dataset.

In some aspects, the techniques described herein relate to a computer-implemented method, including: setting a benchmark accuracy, wherein the benchmark accuracy is a desired level of predictive accuracy of the machine learning model.

In some aspects, the techniques described herein relate to a computer-implemented method, including: determining, after the initial training pass, that the predictive accuracy of the machine learning model is less than the benchmark accuracy.

In some aspects, the techniques described herein relate to a computer-implemented method, wherein the targeted sampling process includes: arranging data files in the remaining dataset in increasing order of predictive confidence based on the initial training pass.

In some aspects, the techniques described herein relate to a computer-implemented method, wherein the targeted sampling process includes: generating a quartile plot, wherein the quartile plot plots data points that represent the data files in the remaining dataset, wherein the quartile plot defines a first quartile, and wherein datapoints in the first quartile represent the number of least learned data files.

In some aspects, the techniques described herein relate to a computer-implemented method, wherein the number of least learned data files is limited to one of a predetermined number of data files and a percentage of the number of data files in the remaining dataset.

In some aspects, the techniques described herein relate to a computer-implemented method, including: executing the targeted sampling process a number of additional iterations, wherein each iteration of the number of additional iterations determines a new number of least learned documents, wherein each new number of least learned documents is included in a new training dataset, and wherein each new training set is used in an additional training pass to train the machine learning model.

In some aspects, the techniques described herein relate to a computer-implemented method, wherein the number of additional iterations cause the predictive accuracy of the machine learning model to equal or exceed the benchmark accuracy.

### BRIEF DESCRIPTION OF THE DRAWINGS

FIG. 1 illustrates a logical flow for sampling and training in a machine learning environment, in accordance with aspects.

FIG. 2 illustrates a block diagram of a system for sampling and training in a machine learning environment, in accordance with aspects.

FIG. 3 is a block diagram of a technology infrastructure and computing device for implementing certain aspects of the present disclosure, in accordance with aspects.

### DETAILED DESCRIPTION

Aspects generally relate to systems and methods for sampling and training in a machine learning environment.

When training machine learning (ML) models, providing the model with large amounts of training data in a single training exercise may make the training less efficient in terms of time and may also result in decreased predictive accuracy. Aspects described herein provide for culling of a training dataset in order to provide a smaller set of highly relevant data files as a training dataset. In model training, a data scientist may define a desired or benchmark threshold for model output. Aspects may train a model to produce a threshold accuracy by training in iterations using a first randomly selected subset of data files. An evaluation/test dataset may be user-annotated and remain constant through the training iterations.

In accordance with aspects, a benchmark (i.e., a desired) accuracy of a machine learning model may be established. Then, a subset of data (e.g., data files such as document files, image files, etc.) may be randomly selected from a larger dataset for a first training dataset for use in a first training iteration. The first training iteration will achieve some accuracy percentage but may not achieve the desired benchmark accuracy. Aspects may initiate subsequent training passes after targeted sampling of the remaining dataset and adding of the targeted data to the initial training dataset to form a second dataset. The second dataset may be used in a second training pass in order to improve the model's predictive accuracy.

Targeted sampling may analyze a remaining dataset to determine the least learned data (e.g., the least learned documents) for inclusion in a second training dataset and a second iteration of a pass. Targeting least learned data for a second iteration of a training pass may facilitate highly effective model training, since the machine learning model has not learned these documents accurately in a first training pass. For example, with respect to an extraction model, a targeted sampling process may add a new subset of documents that the process determines to be least accurately extracted by the model after an initial training pass.

Aspects described herein may be employed to train a new machine learning model (i.e., a model that has not previously been trained) or may be used to retrain a previously trained machine learning model. Aspects may be applied to use cases that involve machine learning (ML) models for document data extraction (e.g., an extraction model for extracting content from image-based files such as portable document format (PDF) documents, image files, a document classification model, etc.) or natural language processing models that process textual data directly.

In accordance with aspects, an implementing organization may provide a repository of training data. The repository of training data may include data files such as digital documents. Document files, e.g., may include characters forming text (e.g., character or string data, as in a word processor document, an HTML document, etc.) and/or image-based documents (e.g., PDF and other image-file formats such as .jpg, .jpeg, .png, etc.). A training data repository may be any suitable data store, such as a data lake, a relational database, a data warehouse, etc.

Aspects may select a number of random data files from a repository of training data. A selected number of random data files may be some fraction of the total number of data/data files in the training data repository. For instance, a document file selection process may select a percentage (e.g., 5%, 10%, 15%, 20%, etc.) of the total number of documents in a training data repository. The randomly selected subset of training data may then be divided into separate subsets. The separate subsets may include one subset that will be used to train the model and one subset that will be used as a evaluation/test dataset (also known as a “hold-out” dataset).

In accordance with aspects, an evaluation or test dataset is a dataset that is not exposed to the model as training data in the training process. That is, the evaluation dataset is specifically held back from the training process. An evaluation dataset may be used to gain an unbiased assessment of a model's predictive accuracy. Because a model is fit on a training dataset, using that same training data as an evaluation dataset would result in a biased accuracy score. Accordingly, a ML model may be trained using (i.e., fit on) a training dataset, and the trained model may then be used to predict responses on an evaluation dataset (i.e., a dataset that the model has not already been exposed to).

In accordance with aspects, a test dataset is a separate set of data used to test the model after completing the training. A test dataset may, ideally, represent the entire data population or data variations. A test dataset may provide an unbiased final model performance metric in terms of accuracy, precision, etc. By assessing the model's performance on previously unseen examples, we the model's ability to generalize and make accurate predictions on new, unseen data may be gauged. A test dataset may provide a metric on how well the model performs the task that it has been trained for.

In accordance with aspects, a subset of data (e.g., a number of random training document files) may be randomly selected from a data repository as discussed, above, and the subset of data may be divided into a training dataset and an evaluation dataset. For instance, two hundred sample documents may be randomly selected from a data repository storing five hundred documents. The two hundred documents may then be evenly split into a 100-document training dataset and a 100-document validation dataset.

In accordance with aspects, a ML model, such as an extraction model, may then be exposed to the training dataset in a model training process. An accuracy benchmark may be established for the training process. For instance, an accuracy benchmark may be arbitrarily set to 95% accuracy, 98% accuracy, etc. An accuracy benchmark is the percentage of predictions that the model should achieve after the training process is complete. Different applications may require relatively higher or lower accuracy percentages from models. Once an accuracy benchmark is established for the training process, a training pass may be executed using the initial training dataset (e.g., the 100-document training dataset described in the example above. As used herein, a “training pass” is a training procedure that trains a ML model on a particular training dataset.

After a first training pass has been executed the model may be tested on an evaluation dataset and an accuracy of the model may be determined. That is, the model may be used to generate predictions based on the entirety of the data in the relevant data repository minus the extracted training dataset and the extracted evaluation dataset (i.e., the “test” dataset). The accuracy of the trained model's predictions with respect to the test dataset may then be determined. For instance, after a first training pass, the trained model may have an initial accuracy of, e.g., 60%.

In accordance with aspects, predictive output will be different for different models. For example, predictive output for an extraction model may be a number of words that are extracted from an image-based document. The initial accuracy of the model may be expressed as extraction confidence. Extraction confidence may be a confidence level that the model has accurately identified all words extracted from image documents in a test dataset.

After a first training pass, aspects may execute a targeted sampling process. In accordance with aspects, a targeted sampling process may be configured to analyze the remaining dataset and determine the least-learned documents. The determined least-learned documents may then be organized into a second training dataset and exposed to the model for a second training pass iteration.

In accordance with aspects, a targeted sampling process may, after an initial training pass, arrange documents from a remaining dataset in increasing order of total extraction confidence of each document. Aspects may use the ML model to predict/extract the data fields from the data sample. The fields extracted correctly or incorrectly from each document contribute to the extraction confidence for an individual document. Each document in the remaining dataset that is arranged in increasing order of extraction confidence may represent a datapoint. A quartile plot may be drawn based on the documents from the remaining dataset as datapoints in the quartile plot (i.e., the samples in a targeted sampling process). A targeted sampling process may determine the first quartile in the quartile plot. The first quartile in the quartile plot of datapoints that represent documents arranged in ascending or increasing order of extraction confidence will represent the documents having the lowest extraction confidence (i.e., the documents “least learned” by the model during any previous training passes).

In accordance with aspects, a targeted sampling process may include an upper limit on the number of documents that are selected as part of the targeted sampling process and that may be included in a second training pass. Aspects may determine the least learned documents, as described above, and if the number of least learned documents are below a predefined upper limit, then all of the least learned documents (e.g., all of the documents represented in a first quartile of a quartile plot) may be selected (i.e., targeted) for inclusion in a second training dataset that may be used in a second training pass with respect to a ML model.

If, however, the number of documents represented in the first quartile is over the defined upper limit of training documents, than the number of documents retrieved to form a new training dataset may be the number represented by the defined upper limit. An upper limit may be defined as an absolute number or as a percentage. For example, an upper limit may be defined as 25 documents, or as, e.g., 5% or 10% of the total number of documents in the remaining dataset.

In accordance with aspects, the documents retrieved by a targeted sampling process may be added to the original training dataset to form a second training dataset. A second training dataset may then be used in a second training pass. After a second training pass has been completed with a second training dataset, the accuracy of the model being trained may again be determined. If the accuracy of the model has improved (i.e., if the accuracy of the model after the second training pass is greater than the accuracy of the model after the first training pass) but is still below the accuracy benchmark defined for the model, the targeted sampling process may be reiterated. The targeted sampling process and subsequent training passes using training datasets that include targeted document samples may be reiterated until the model's accuracy reaches the defined accuracy benchmark or until the latest training dataset is less than the third quartile of the entire dataset (i.e., the entire original dataset, e.g., housed in a repository) minus the initial training dataset.

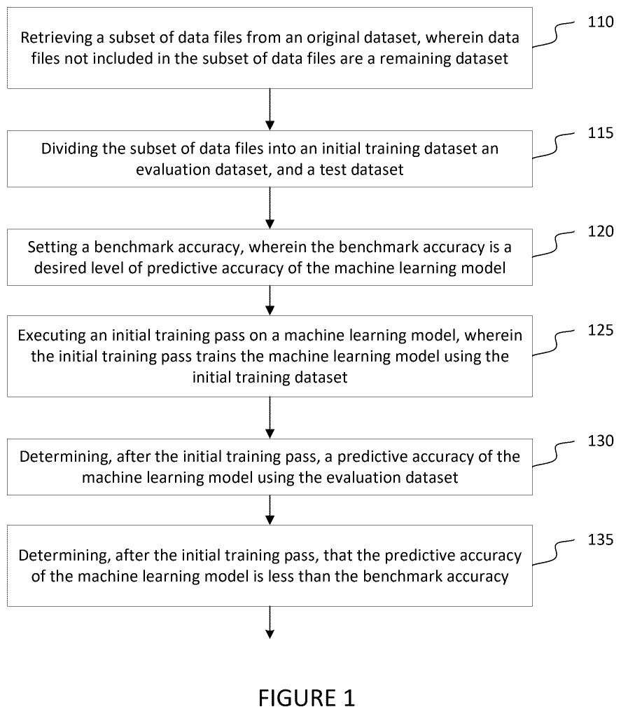

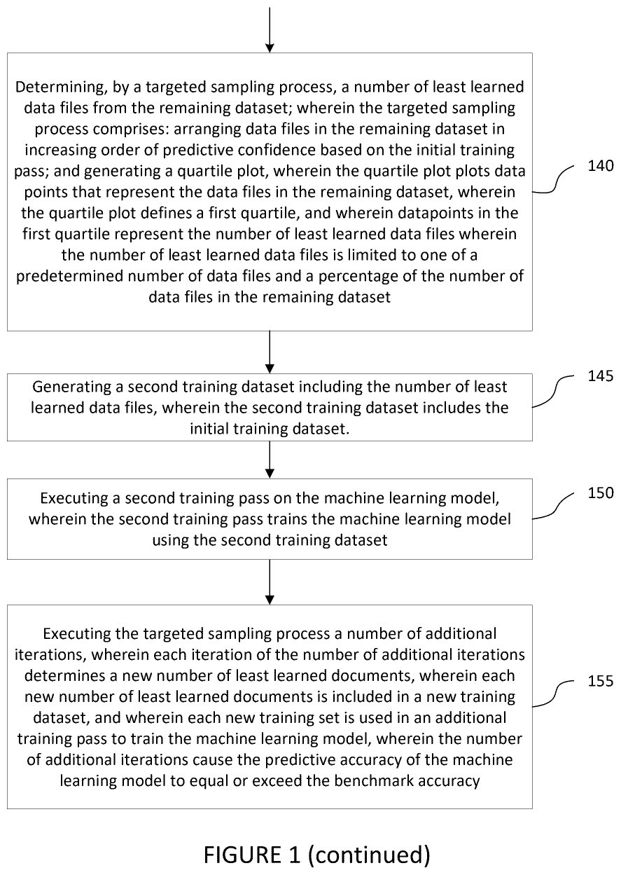

FIG. 1 illustrates a logical flow for targeted sampling and accelerated training in a machine learning environment, in accordance with aspects.

Step 110 includes retrieving a subset of data files from an original dataset, wherein data files not included in the subset of data files are a remaining dataset.

Step 115 includes dividing the subset of data files into an initial training dataset and an evaluation dataset, and a test dataset.

Step 120 includes setting a benchmark accuracy, wherein the benchmark accuracy is a desired level of predictive accuracy of the machine learning model.

Step 125 includes executing an in initial training pass on a machine learning model, wherein the initial training pass trains the machine learning model using the initial training dataset.

Step 130 includes determining, after the initial training pass, a predictive accuracy of the machine learning model using the evaluation dataset.

Step 135 includes determining, after the initial training pass, that the predictive accuracy of the machine learning model is less than the benchmark accuracy.

Step 140 includes determining, by a targeted sampling process, a number of least learned data files from the remaining dataset; wherein the targeted sampling process comprises: arranging data files in the remaining dataset in increasing order of predictive confidence based on the initial training pass; and generating a quartile plot, wherein the quartile plot plots data points that represent the data files in the remaining dataset, wherein the quartile plot defines a first quartile, and wherein datapoints in the first quartile represent the number of least learned data files wherein the number of least learned data files is limited to one of a predetermined number of data files and a percentage of the number of data files in the remaining dataset.

Step 145 includes generating a second training dataset including the number of least learned data files, wherein the second training dataset includes the initial training dataset.

Step 150 includes executing a second training pass on the machine learning model.

Step 155 includes executing the targeted sampling process a number of additional iterations, wherein each iteration of the number of additional iterations determines a new number of least learned documents, wherein each new number of least learned documents is included in a new training dataset, and wherein each new training set is used in an additional training pass to train the machine learning model, wherein the number of additional iterations cause the predictive accuracy of the machine learning model to equal or exceed the benchmark accuracy.

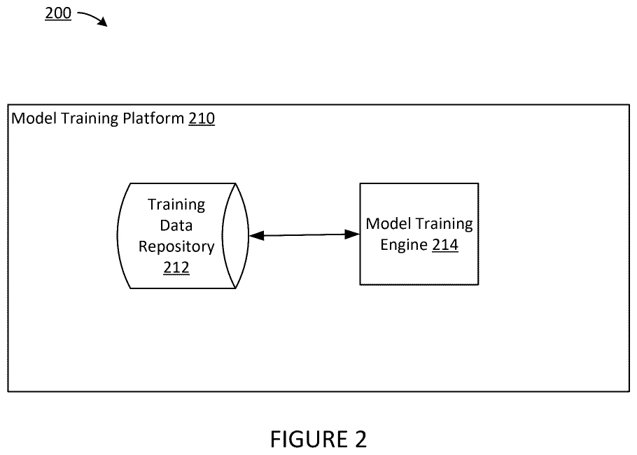

FIG. 2 illustrates a block diagram of a system for targeted sampling and accelerated training in a machine learning environment, in accordance with aspects.

System 200 includes model training platform 210, which includes training data repository 212 and model training engine 214. Model training platform 210 may be included as part of an implementing organization's technology infrastructure. Training data repository 212 may be any suitable datastore for storing training data such as electronic data files (e.g., electronic document files, image files, etc.). Training data repository 212 may be a data lake, a relational database, a NoSQL database, etc. Model training engine 214 may be configured to execute model training procedures and other processes including training passes and a targeted sampling process using data from training data repository 212 and as described in more detail, herein.

Model training engine 214 may be configured for operative communication with training data repository 212. Model training engine 214 may be configured to retrieve training datasets, evaluation datasets, test datasets, etc., from training data repository 212 as described in more detail herein. Model training platform 210 and/or model training engine 214 may include interfaces such as graphical user interfaces, application programming interfaces, etc., through which users or computer programs may interface, interact, pass data to, and retrieve data from model training platform 210 and/or model training engine 214.

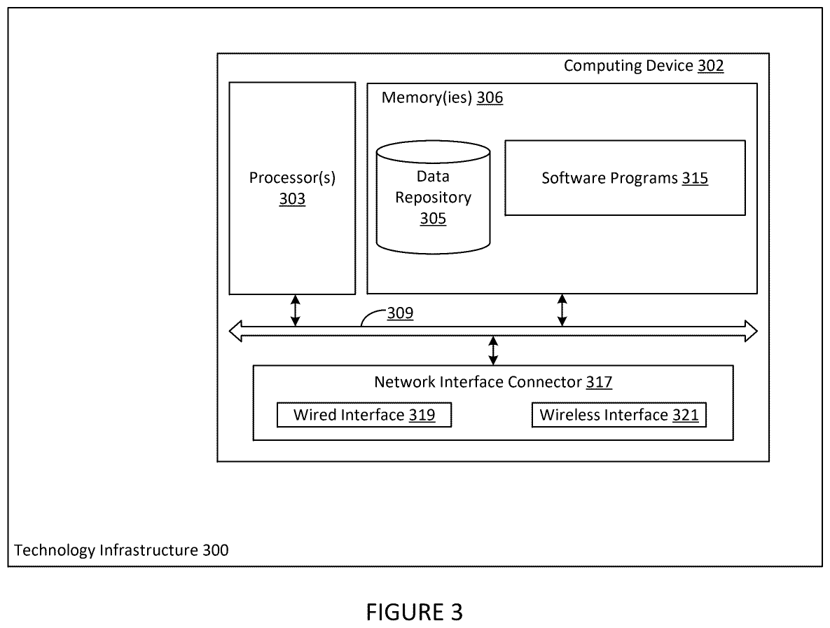

FIG. 3 is a block diagram of a technology infrastructure and computing device for implementing certain aspects of the present disclosure, in accordance with aspects. FIG. 3 includes technology infrastructure 300. Technology infrastructure 300 represents the technology infrastructure of an implementing organization. Technology infrastructure 300 may include hardware such as servers, client devices, and other computers or processing devices. Technology infrastructure 300 may include software (e.g., computer) applications that execute on computers and other processing devices. Technology infrastructure 300 may include computer network mediums, and computer networking hardware and software for providing operative communication between computers, processing devices, software applications, procedures and processes, and logical flows and steps, as described herein.

Exemplary hardware and software that may be implemented in combination where software (such as a computer application) executes on hardware. For instance, technology infrastructure 300 may include webservers, application servers, database servers and database engines, communication servers such as email servers and SMS servers, client devices, etc. The term “service” as used herein may include software that, when executed, receives client service requests and responds to client service requests with data and/or processing procedures. A software service may be a commercially available computer application or may be a custom-developed and/or proprietary computer application. A service may execute on a server. The term “server” may include hardware (e.g., a computer including a processor and a memory) that is configured to execute service software. A server may include an operating system optimized for executing services. A service may be a part of, included with, or tightly integrated with a server operating system. A server may include a network interface connection for interfacing with a computer network to facilitate operative communication between client devices and client software, and/or other servers and services that execute thereon.

Server hardware may be virtually allocated to a server operating system and/or service software through virtualization environments, such that the server operating system or service software shares hardware resources such as one or more processors, memories, system buses, network interfaces, or other physical hardware resources. A server operating system and/or service software may execute in virtualized hardware environments, such as virtualized operating system environments, application containers, or any other suitable method for hardware environment virtualization.

Technology infrastructure 300 may also include client devices. A client device may be a computer or other processing device including a processor and a memory that stores client computer software and is configured to execute client software. Client software is software configured for execution on a client device. Client software may be configured as a client of a service. For example, client software may make requests to one or more services for data and/or processing of data. Client software may receive data from, e.g., a service, and may execute additional processing, computations, or logical steps with the received data. Client software may be configured with a graphical user interface such that a user of a client device may interact with client computer software that executes thereon. An interface of client software may facilitate user interaction, such as data entry, data manipulation, etc., for a user of a client device.

A client device may be a mobile device, such as a smart phone, tablet computer, or laptop computer. A client device may also be a desktop computer, or any electronic device that is capable of storing and executing a computer application (e.g., a mobile application). A client device may include a network interface connector for interfacing with a public or private network and for operative communication with other devices, computers, servers, etc., on a public or private network.

Technology infrastructure 300 includes network routers, switches, and firewalls, which may comprise hardware, software, and/or firmware that facilitates transmission of data across a network medium. Routers, switches, and firewalls may include physical ports for accepting physical network medium (generally, a type of cable or wire—e.g., copper or fiber optic wire/cable) that forms a physical computer network. Routers, switches, and firewalls may also have “wireless” interfaces that facilitate data transmissions via radio waves. A computer network included in technology infrastructure 300 may include both wired and wireless components and interfaces and may interface with servers and other hardware via either wired or wireless communications. A computer network of technology infrastructure 300 may be a private network but may interface with a public network (such as the internet) to facilitate operative communication between computers executing on technology infrastructure 300 and computers executing outside of technology infrastructure 300.

FIG. 3 further depicts exemplary computing device 302. Computing device 302 depicts exemplary hardware that executes the logic that drives the various system components described herein. Servers and client devices may take the form of computing device 302. While shown as internal to technology infrastructure 300, computing device 302 may be external to technology infrastructure 300 and may be in operative communication with a computing device internal to technology infrastructure 300.

In accordance with aspects, system components such as a model training platform, a model training engine, a training data repository, client devices, servers, various database engines and database services, and other computer applications and logic may include, and/or execute on, components and configurations the same, or similar to, computing device 302.

Computing device 302 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 302 may also have user interface components, such as a screen for displaying graphical user interfaces and receiving input from the user, a mouse, a keyboard and/or other input/output components (not shown).

In accordance with aspects, services, modules, engines, etc., described herein may provide one or more application programming interfaces (APIs) in order to facilitate communication with related/provided computer applications and/or among various public or partner technology infrastructures, data centers, or the like. APIs may publish various methods and expose the methods, e.g., via API gateways. A published API method may be called by an application that is authorized to access the published API method. API methods may take data as one or more parameters or arguments of the called method. In some aspects, API access may be governed by an API gateway associated with a corresponding API. In some aspects, incoming API method calls may be routed to an API gateway and the API gateway may forward the method calls to internal services/modules/engines that publish the API and its associated methods.

A service/module/engine that publishes an API may execute a called API method, perform processing on any data received as parameters of the called method, and send a return communication to the method caller (e.g., via an API gateway). A return communication may also include data based on the called method, the method's data parameters and any performed processing associated with the called method.

API gateways may be public or private gateways. A public API gateway may accept method calls from any source without first authenticating or validating the calling source. A private API gateway may require a source to authenticate or validate itself via an authentication or validation service before access to published API methods is granted. APIs may be exposed via dedicated and private communication channels such as private computer networks or may be exposed via public communication channels such as a public computer network (e.g., the internet). APIs, as discussed herein, may be based on any suitable API architecture. Exemplary API architectures and/or protocols include SOAP (Simple Object Access Protocol), XML-RPC, REST (Representational State Transfer), or the like.

The various processing steps, logical steps, and/or data flows depicted in the figures and described in greater detail herein may be accomplished using some or all of the system components also described herein. In some implementations, the described logical steps or flows may be performed in different sequences and various steps may be omitted. Additional steps may be performed along with some, or all of the steps shown in the depicted logical flow diagrams. Some steps may be performed simultaneously. Some steps may be performed using different system components. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing device,” a “computing device,” a “computer,” an “electronic device,” a “mobile device,” a “client device,” a “server,” etc. As used herein, these terms (unless otherwise specified) are to be understood to include at least one processor that uses at least one memory. The at least one memory may store a set of instructions. The instructions may be either permanently or temporarily stored in the memory or memories of the processing device. The processor executes the instructions that are stored in the memory or memories in order to process data. A set of instructions may include various instructions that perform a particular step, steps, task, or tasks, such as those steps/tasks described above, including any logical steps or logical flows described above. Such a set of instructions for performing a particular task may be characterized herein as an application, computer application, program, software program, service, or simply as “software.” In one aspect, a processing device may be or include a specialized processor. As used herein (unless otherwise indicated), the terms “module,” and “engine” refer to a computer application that executes on hardware such as a server, a client device, etc. A module or engine may be a service.

As noted above, the processing device executes the instructions that are stored in the memory or memories to process data. This processing of data may be in response to commands by a user or users of the processing device, in response to previous processing, in response to a request by another processing device and/or any other input, for example. The processing device used to implement the invention may utilize a suitable operating system, and instructions may come directly or indirectly from the operating system.

The processing device used to implement the invention may be a general-purpose computer. However, the processing device described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing device be physically located in the same geographical place. That is, each of the processors and the memories used by the processing device may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing device what to do with the data being processed.

Further, it is appreciated that the instructions or set of instructions used in the implementation and operation of the invention may be in a suitable form such that the processing device may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing device, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing device, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing device, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing device that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing device or machines that are used to implement the invention. As used herein, a user interface includes any hardware, software, or combination of hardware and software used by the processing device that allows a user to interact with the processing device. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing device as it processes a set of instructions and/or provides the processing device with information. Accordingly, the user interface is any device that provides communication between a user and a processing device. The information provided by the user to the processing device through the user interface may be in the form of a command, a selection of data, or some other input, for example.

As discussed above, a user interface is utilized by the processing device that performs a set of instructions such that the processing device processes data for a user. The user interface is typically used by the processing device for interacting with a user either to convey information or receive information from the user. However, it should be appreciated that in accordance with some aspects of the system and method of the invention, it is not necessary that a human user actually interact with a user interface used by the processing device of the invention. Rather, it is also contemplated that the user interface of the invention might interact, i.e., convey and receive information, with another processing device, rather than a human user. Accordingly, the other processing device might be characterized as a user. Further, it is contemplated that a user interface utilized in the system and method of the invention may interact partially with another processing device or processing devices, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A computer-implemented method comprising:
retrieving a subset of data files from an original dataset, wherein data files not included in the subset of data files are a remaining dataset;
dividing the subset of data files into an initial training dataset and an evaluation dataset;
executing an in initial training pass on a machine learning model, wherein the initial training pass trains the machine learning model using the initial training dataset;
determining, after the initial training pass, a predictive accuracy of the machine learning model using the evaluation dataset;
determining, by a targeted sampling process, a number of least learned data files from the remaining dataset;
generating a second training dataset including the number of least learned data files, wherein the second training dataset includes the initial training dataset; and
executing a second training pass on the machine learning model, wherein the second training pass trains the machine learning model using the second training dataset.

2. The computer-implemented method of claim 1, comprising:
setting a benchmark accuracy, wherein the benchmark accuracy is a desired level of predictive accuracy of the machine learning model.

3. The computer-implemented method of claim 2, comprising:
determining, after the initial training pass, that the predictive accuracy of the machine learning model is less than the benchmark accuracy.

4. The computer-implemented method of claim 1, wherein the targeted sampling process comprises:
arranging data files in the remaining dataset in increasing order of predictive confidence based on the initial training pass.

5. The computer-implemented method of claim 4, wherein the targeted sampling process comprises:
generating a quartile plot, wherein the quartile plot plots data points that represent the data files in the remaining dataset, wherein the quartile plot defines a first quartile, and wherein datapoints in the first quartile represent the number of least learned data files.

6. The computer-implemented method of claim 5, wherein the number of least learned data files is limited to one of a predetermined number of data files and a percentage of the number of data files in the remaining dataset.

7. The computer-implemented method of claim 2, comprising:
executing the targeted sampling process a number of additional iterations, wherein each iteration of the number of additional iterations determines a new number of least learned documents, wherein each new number of least learned documents is included in a new training dataset, and wherein each new training set is used in an additional training pass to train the machine learning model.

8. The computer-implemented method of claim 7, wherein the number of additional iterations cause the predictive accuracy of the machine learning model to equal or exceed the benchmark accuracy.
